(19) United States
(12) Patent Application Publication
(10) Pub. No.: US 2023/0144302 A1
(43) Pub. Date: May 11, 2023

(54) METHOD FOR AUTOMATED PRODUCTION OF READY-TO-EAT FLOUR-BASED CULINARY PRODUCT

(71) Applicant: Igor Sergeevich LERNER, Yaroslavl (RU)

(72) Inventor: Igor Sergeevich LERNER, Yaroslavl (RU)

(21) Appl. No.: 17/924,442

(22) PCT Filed: Aug. 5, 2021
(86) PCT No.: PCT/RU2021/000335

§ 371 Date: Nov. 10, 2022

(30) Foreign Application Priority Data
Aug. 20, 2020 (RU) 2020127795

(51) Int. Cl. A21D 13/31; A21C 15/04; B65B 25/16; B07C 5/18; B07C 5/342

(52) U.S. Cl. CPC A21D 13/31; A21C 15/04; B07C 5/18; B07C 5/3422; B65B 25/16; A21B 1/48

(57) ABSTRACT

The invention relates to the food industry. A method includes generating, via a server of a system, a selected order for processing by a control computer, as a result of which the necessary food base, which is located in a refrigerating unit, is sent to a first transport device where specific food ingredients are added in a prescribed manner, said ingredients being released from containers mounted above the first transport device. After this, the partially finished product is transferred to a second transport device, and, while moving along it, is baked to a finished condition in a baking unit. Then the baked product is transferred to a packaging sub-system which is connected to a sub-system for temporary storage and dispensing of the finished and packaged product.

### FIELD OF THE INVENTION

The present invention relates to the field of a technologically advanced, automated and fully integrated technology for producing and packaging instant food products, namely, ready-to-eat flour culinary products which are mainly round and relatively flat in shape, such as pizza, tortillas, pancakes, shawarma, sandwiches, pies, burrito, hamburgers, etc.

### BACKGROUND OF THE INVENTION

The prior art discloses a technology for preparing baked food products (see [1]: SU 406326, IPC A21C 5/00, published Nov. 5, 1973).

This technology is implemented based on equipment for the food industry which is related to systems for preparing pizza-type dough products.

This technology involves the machine-stacking of dough pieces by using a feeding device onto a transport device configured a conveyor having an endless belt. The dough pieces move on the belt and are filled with certain food ingredients emitted from containers installed in series above the belt. After that, the products moving forward enters conveyor ovens for heat treatment, whereupon the products are removed and ready for direct use.

A notable feature of this technology is that a single dough mass is used for the preparation of the dough pieces. The single dough mass is stored in a special container, removed in portions by the feeding device installed on a suspension bracket, and located on the belt sections of a certain shape and size. The dough pieces are subsequently molded by means of a special device in the form of a lever with a disk.

The communication capabilities of this food production technology are very superficial and do not allow interacting with modern digital communication equipment. Therefore, it does not seem possible to organize orders for resulting products remotely by using electronic services, which in fact will not allow one to place orders remotely, including individual orders with a selection of cooking modes and delivery conditions.

It should also be noted that most of the devices and systems which embody the above-indicated technology operate in a mechanical mode, thereby requiring the continuous participation of several people in their operation. Accordingly, the quality of production decreases since the combination of manual labor and the manually served system configured to operate at a fast pace is associated with the manifestation of errors and inaccuracies in work. In addition, the speed of work decreases since it is impossible to ensure a continuous cycle of operation of the whole installation due to the need to change personnel, serve the containers with dough and food additives, as well as take preventive measures.

These drawbacks characterize the technical solution known from [1] as a technology having an incomplete automation cycle, low manufacturability and, accordingly, low technical and operational capabilities.

The prior art discloses a technology for the personalized production of food products (see [2]: EP 3220743, IPC A21C 15/00, published Dec. 12, 2018).

The technology known from [2] is implemented based on an automatic system for producing flour culinary products (pizza, focaccia bread, etc.) on an individual order.

The technology known from [2] involves the preparation of dough pieces and their laying out from a storage section onto a conveyor subsystem having an endless belt, along which dough portions move and are subsequently filled with various ingredients. After that, the portions enter a dough heat treatment section, where they are baked and subsequently enter a section for storing and delivering finished products to a buyer.

The above-listed devices are controlled and operated by a computer system, and the initial personalized selection of a resulting product with its cooking parameters and other features is implemented directly through an additional product selection section which is equipped with a user interface.

From a technological point of view, the technical solution disclosed in [2] is characterized by the possibility of identifying food products and associating them with certain buyers, as well as the possibility for the buyers to independently manage the user interface of the selection section and select the food products themselves, setting the parameters for their preparation/baking and determining the amount of food ingredients applied both before and after heat treatment.

The possibility of controlling almost all production stages, as well as the possibility of inspecting moving products and providing access to them at some stages increases consumer attractiveness and has a complex positive effect on the quality and accuracy of manufacturing the selected products. However, with this design, one cannot exclude the likelihood of accidental or deliberate contact of food products with foreign objects, which, in the absence of modern quality control tools, can lead to extremely undesirable consequences.

The serious drawbacks of the technology known from [2] should also include an unreasonably complex, sweeping and non-standard scheme for distributing interconnected numerous equipment with separately installed subsystems, which will require high operating costs for installation, configuration and periodic software and hardware maintenance of systems.

The prior art discloses an automated technology for making pizza (see [3]: WO 19224799, IPC A21C 15/04, published Nov. 28, 2019).

The technology disclosed in [3] relates to the field of food production, and more particularly to automated pizza making processes that involve using robotic subsystems and automated dosing devices configured to operate according to individual algorithms.

The technology known from [3] consists in pizza production and packaging, and involves generating a selected order which is received as an information signal to a system control unit. The system control unit processes the information signal and approves control commands and operation modes of the equipment used. As a result, a desired dough piece is fed by a dough piece feeding means on the belt of a main conveyor, on which the dough piece is subjected to consistent and calculated replenishment with certain food ingredients, including processed ones, emitted from containers alternately installed above the belt of the main conveyor. After that, a partially finished product is provided, using a transfer mechanism, to an oven conveyor. Moving along the belt of the oven conveyor, it is baked until cooked, after which a finished product is fed to an equipped section where it is cut into pieces and subsequently placed into a system for packaging and issuing the finished product, which feeds it to an automatic user window.

The technology known from [3] is fully automated and provides the possibility of placing an order through a mobile application of a smartphone or tablet. However, to guarantee the preparation of products of proper quality, the applied technological operations need to be under continuous quality control, which ensures the detection of products that do not meet certain product-specific requirements, as well as their extraction for the purpose of revision or disposal. This is because the above-mentioned possibility as such is not provided, which causes certain risks of obtaining low-quality, and possibly hazardous to health, products that come directly to a consumer.

It is also important to note that the technology known from [3] uses electric belt conveyors to move the dough pieces, which are programmed to move with alternating stops and starts. Under intensive use, this can lead to inaccuracies in the positioning of the belt and, accordingly, to malfunctions and will require technical intervention to eliminate the malfunctions. In addition, the use of the conveyor in any systems requires increased energy resources and is inevitably associated with scheduled maintenance activities, for which reason one can conclude that the maintenance of the technology known from [3] is burdensome and low-productive.

### SUMMARY OF THE INVENTION

The technical problem solved by the present invention is to create a universal, automated and fully integrated technology for producing and packaging ready-to-eat flour culinary products, which has a wide range of functionalities and high technical and operational performance.

The technical result of the present invention, which objectively manifests itself when using the invention, is the implementation of the purpose of creating a technologically advanced and automated food production process which may be user-programmed to select a desired food product and determine its composition and characteristics of the preparation taking place under controlled conditions with increased safety and improved quality in terms of compliance with the generally accepted characteristics of resulting food products.

The above-indicated technical result, which solves the above-indicated technical problem, is achieved due to the fact that a method for automatically producing and packaging ready-to-eat flour products comprises generating a selected order which is provided as a digital information signal from a central system server to a local control computer connected to an Internet network. The control computer processes it, approving programmed control commands and operation modes of system components. As a result, a necessary food base, which is placed in a cooling unit, is fed by a device for withdrawing and feeding food bases to a first transport device, where it is filled, in a prescribed manner, with certain food ingredients emitted from containers installed above the first transport device. After that, a partially finished product is fed by a transferring means to a second transport device, moving along which it is baked until cooked in an oven unit. After the oven unit, a baked product enters a working section configured to transfer it to a packaging subsystem connected to a subsystem for temporarily storing and issuing a finished and packaged product, which feeds an ordered product to an automatically opening user area. At the outlets of the first and second transport devices, digital product quality monitoring tools are installed, and images of products are transmitted to a computer system which analyses the received images by comparing them with reference images, and in case of an unsatisfactory comparison result, generates and transmits a signal to withdraw low-quality products, which is implemented by actuators.

According to one of the rational embodiments of the proposed technology, the digital product quality monitoring tools comprise a photo and/or video camera.

More preferably, the first transport device is implemented as a movable two-axis worktable mounted on guides.

As a rule, the two-axis worktable comprises a base having a movable platform installed thereon, the movable platform having a lower part configured to move in a longitudinal direction and an upper part configured to move in a transverse direction.

It is most effective and successful if the two-axis worktable is equipped with a digital product quality monitoring tool.

More preferably, the digital product quality monitoring tool mounted on the two-axis worktable is implemented as a photo and/or video camera.

It is more effective and justified if the control computer is configured to: analyze the received images from the product quality monitoring tool installed on the two-axis worktable mainly in combination with the received images from a product quality monitoring tool installed on an exit section of the two-axis worktable; generates, in case of incomplete reference compliance of the products, programmed command signals that activate desired operation modes of the equipment which are aimed at eliminating deficiencies of the products.

According to one of embodiments of the present invention, the first transport device is implemented as a conveyor device having an endless belt.

According to one of the most rational embodiments of the present invention, the second transport device is implemented as a conveyor device having an endless belt.

As a rule, the cooling unit is a refrigerating chamber for storing the food bases, which is structurally docked with the first transport device.

According to one of embodiments of the proposed technology, the containers by which the food bases are filled with the food ingredients in a prescribed manner are installed sequentially in a row and comprise free-flowing, pasty, solid, semi-solid and liquid additives.

The working section provided in the proposed technology may be equipped with a checkweigher configured to measure a weight of products, and data on the weight are used by the computer when analyzing the received images. If this parameter deviates from pre-loaded statutory indicators, a decision is made to withdraw the low-quality products.

According to the most enhanced and technologically advanced embodiments of the present invention, the working section is equipped with a press-mechanism for cutting baked products.

According to a preferred embodiment of the present invention, the applied production equipment is operatively combined into a system and covered with a transparent protective showcase for safe and visual viewing.

In the proposed technology, the actuators may be arranged within transfer sections of the transport devices and implemented as separate controllable modules equipped with a piston-pusher having a stop and configured to transfer the low-quality products to a storage.

Furthermore, the actuators according to the present invention may also be arranged on movable parts of the transport devices and represent separate controllable units configured as a piston-pusher having a stop and configured to transfer the low-quality products to the storage.

According to the inventive concept, the essence of the subject-matter to be patented is to create the technically advanced production process that automatically produces ready-to-eat flour culinary products, the preparation of which is performed cyclically using operatively interconnected equipment configured, depending on its purpose, to perform certain technological operations.

The main technological operations of the proposed technology, which determine its purpose and desired performance indicators, consist in generating the electronic order indicating the type and parameters of desired products, which is compiled and activated by a user or operator and enters the computer system that, processing the order, generates and approves the previously programmed control commands supporting certain operation modes and parameters necessary for the high-quality preparation of each order separately. As a result of this, the automated production process is provided, which consists in feeding blanks into the transport device, filling the blanks with contents, baking them, and packaging and issuing them to a customer. At the same time, the quality and safety of these operations are additionally ensured by the command and executive monitoring product quality tools which performs continuous production control with software quality analysis, thereby allowing the withdrawal of the products that have not passed the check.

As the main equipment for receiving and processing digital orders, the central server is used, which is connected to the Internet network or to a similar data network transmitting information to the control computer. In turn, by processing the received signals about the selection of certain products and their preparation modes, the control computer generates control commands that determine, for the entire production cycle of a certain product, the operation modes and features of the transport devices by which the products are moved, the refrigerating chamber, ingredient feeding devices, the conveyor oven, as well as the packaging subsystem and the subsystem for storing and issuing the finished products.

Thus, according to the inventive concept, the computer system used comprehensively controls the technological capabilities, ensures uninterrupted automated operation and consistency of all the main and auxiliary systems used, including the organization of processing and generation of control commands, the automated reproduction of which ensures the smooth and organized operation of systems with a certain high level of manufacturability, complemented by the controlled and technically advanced operation of the monitoring tools. The latter implies a software analytical analysis of the quality of both finished and partially finished products, which provides an unprecedented increase in production safety, improved control, as well as the corresponding product quality features which are comparable to those for reference products produced by hand.

Thus, given its characteristics and technical features, the above-described process for automatically preparing and packaging the ready-to-eat flour products forms a set of features sufficient to achieve the above-indicated technical result consisting in implementing the purpose of creating the technically advanced and automated process for obtaining food products, which may be programmed to select a desired product, determine its composition and features of its preparation taking place under controlled conditions with increased safety and improved quality in terms of compliance with the generally accepted characteristics of resulting food products, as well as to solve the existing technical problem of creating the universal, automated and fully integrated technology for producing and packaging the ready-to-eat flour culinary products, which has a wide range of functionalities and high performance indicators.

### BRIEF DESCRIPTION OF THE DRAWINGS

FIG. 1 shows a layout of equipment used when implementing the proposed method for automatically preparing and packaging ready-to-eat flour products;

FIG. 2 shows an embodiment of a cooling unit with equipment that places food bases on a first transport device;

FIG. 3 shows an embodiment of a two-axis worktable;

FIG. 4 shows an embodiment of a sequentially arranged group of food distribution units;

FIG. 5 shows an embodiment of a subsystem for storing and issuing a finished and packaged product;

FIG. 6 shows a container for food solid or semi-solid ingredients and a device for issuing them in the form of a dispenser having a grater;

FIG. 7 shows a container for food solid or semi-solid ingredients and a device for issuing them in the form of a dispenser having knives;

FIG. 8 shows a container for liquid food ingredients and a device for issuing them in the form of a dispenser having a peristaltic pump;

FIG. 9 shows a container for free-flowing food ingredients and a device for issuing them in the form of a dispenser which is a cone crusher.

### DETAILED DESCRIPTION OF THE INVENTION

The proposed method for automatically preparing and packaging flour products is illustrated by a specific example of its implementation, which, however, is not the only possible, but clearly demonstrates the achievement of the above-indicated technical result by the specified set of essential features, as well as the solution of the existing technical problem.

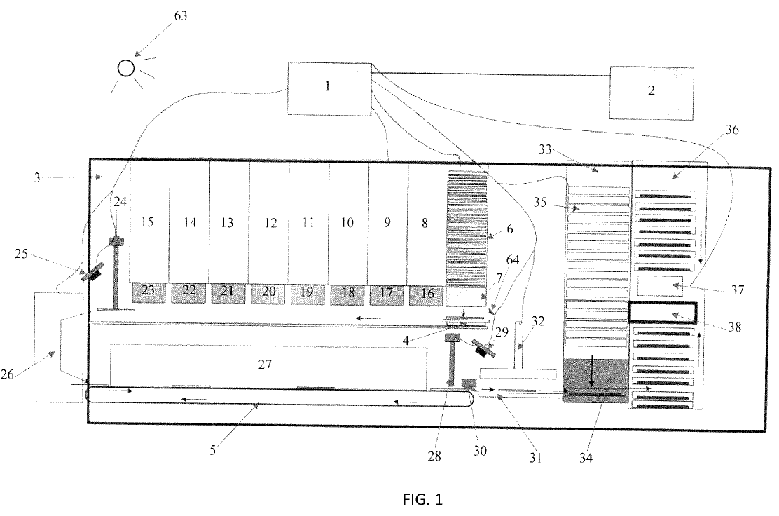

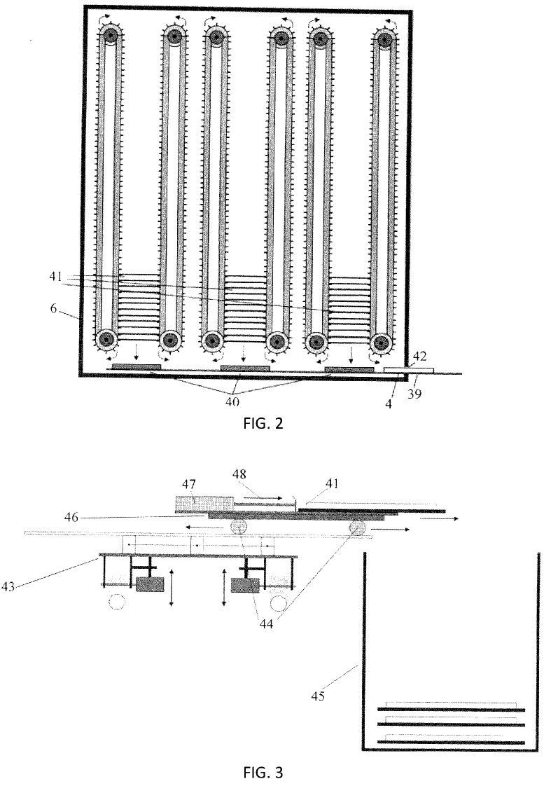

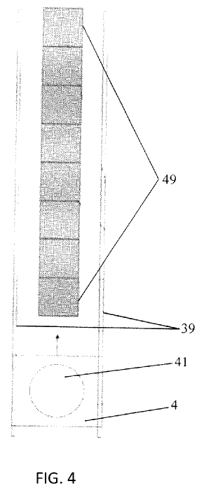

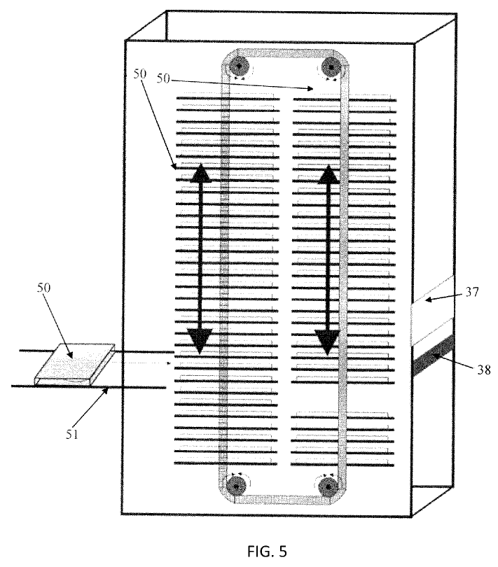

FIGS. 1-9 show the following parts and elements of the equipment used to implement the proposed method for automatically preparing and packaging instant flour products:
1 - control computer;
2 - central server;
3 - transparent showcase;
4 - two-axis worktable;
5 - electric conveyor having an endless belt;
6 - refrigerating chamber;
7 - device for withdrawing and feeding food bases to the two-axis worktable;
8 - first container for food ingredients;
9 - second container for food ingredients;
10 - third container for food ingredients;
11 - fourth container for food ingredients;
12 - fifth container for food ingredients;
13 - sixth container for food ingredients;
14 - seventh container for food ingredients;
15 - eighth container for food ingredients;
16 - first device for processing and issuing food ingredients;
17 - second device for processing and issuing food ingredients;
18 - third device for processing and issuing food ingredients;
19 - fourth device for processing and issuing food ingredients;
20 - fifth device for processing and issuing food ingredients;
21 - sixth device for processing and issuing food ingredients;
22 - seventh device for processing and issuing food ingredients;
23 - eighth device for processing and issuing food ingredients;
24 - actuator for withdrawing a thermally untreated product of inadequate quality;
25 - first video camera;
26 - means for transferring a partially finished product;
27 - conveyor oven;
28 - actuator for withdrawing a thermally treated product of inadequate quality;
29 - second video camera;
30 - element for transferring a resulting baked product to a packaging subsystem;
31 - working section;
32 - press-mechanism for cutting products;
33 - packaging subsystem;
34 - mechanism for packaging products;
35 - empty packages;
36 - subsystem for storing and issuing a finished and packaged product;
37 - touchscreen;
38 - window for issuing the finished and packaged product;
39 - guides of the two-axis worktable;
40 - stopping portions of the two-axis worktable in the refrigerating chamber;
41 - blanks of food bases;
42 - technological opening of the refrigerating chamber;
43 - basis of the two-axis worktable;
44 - servo drives;
45 - storage for recycled products;
46 - platform;
47 - pusher;
48 - piston;
49 - group of food distribution units;
50 - packaged products;
51 - movable feed element;
52 - body;
53 - food ingredient;
54 - chopper;
55 - chopper clamps;
56 - chopper motor and drive;
57 - plates with knives;
58 - clamps of the plates with knives;
59 - motor and drive of the plate with knives;
60 - peristaltic pump;
61 - motor and drive of a cone crusher;
62 - cone crusher;
63 - ultraviolet lamps;
64 - third video camera.

The proposed method for automatically preparing and packaging instant flour products may be implemented as follows.

It should be noted that the purpose of the following description of the present invention is not to limit it to a specific embodiment, but rather to cover all possible additions that do not go beyond the scope of the appended claims.

Production processes are controlled by a control computer 1 which is coupled to a central server 2 and connected to an Internet network. The control computer 1 and the central server 2 are provided with software for transmitting information about incoming orders and about the operation of the equipment connected to them.

It is possible to order a certain instant food product, as well as select, if desired, its filling and preparation features through a software application, at a manufacturer’s website, by using any mobile device (phone, tablet, etc.), or directly on site by using a touchscreen 37 arranged within the area for issuing finished and packaged products. As a rule, an order consists of electronic information about a product type (pizza, tortilla, pancakes, fritters, burrito, sandwich, shawarma, pies, hamburgers, etc.), a filing type and other features, baking time, the time by which products must be ready, etc. The control computer 1 controlling the production process receives an electronic signal, processes it by means of a software algorithm, as well as forms and subsequently controls a certain operation mode of the equipment used for the preparation of a specific product. At the same time, the central server 2 has a database comprising all possible programs for preparing flour culinary products, such as pizzas, tortillas, pancakes, fritters, burrito, sandwiches, shawarma, pies, hamburgers, etc., as well as algorithms for selecting blanks for food bases 41, serving food ingredients 53, preparation modes and features, options for cutting and packaging products.

The main production equipment may be arranged longitudinally in one row, may be arranged horizontally one under another or sideways relative to each other. The equipment may be also provided in the form of several rows of randomly arranged systems on the same level. Any other options for arranging the equipment are also possible, which do not go beyond the scope of the appended claims.

However, in the embodiment under consideration, the main production equipment is operatively combined for visual inspection and protected by a transparent showcase 3.

According to the present invention, it is supposed to use pre-prepared frozen food bases made as rolled dough pieces of various shapes and sizes, or directly as rolls, pieces of bread, pita bread, etc., which are laid on a solid substrate, thereby forming a blank 41 of food bases. The food bases are placed with a certain frequency on solid substrates in a cooling unit which is represented by a refrigerating chamber 6, thereby forming the blanks 41 of food bases that may later be used for the preparation of products.

Each blank 41 is associated by an equipment operator with a certain shelf in the refrigerating chamber 6 and entered into the database of the central server 2.

After the central server 2 receives information about the order of a certain product, the control computer 1 generates, by means of a software algorithm, a command for a device 7 for withdrawing and feeding the food bases to a first transport device which is represented by a two-axis worktable 4. Said device 7 is implemented as groups of double vertically oriented conveyor-type mechanisms which hold the food bases on the substrates (blanks 41) with the help of jumpers installed on belts. The controlled movement of the belts ensures that the blanks are separated and stacked in a required place on the two-axis worktable 4. Thus, the device 7 delivers the blank 41, which the software, having identified with the order, selects as necessary for the preparation of the product (pizza, tortillas, pancakes, fritters, burrito, sandwiches, shawarma, pies, hamburgers, etc.), to stopping portions 40 of the two-axis worktable 4 which is periodically moved along guides 39 to the refrigerating chamber 6 through its technological opening 42. This operation becomes possible since the central server 2 stores the coordinates and numbers of conditional shelves with all types and kinds of the blanks 41 of the food bases loaded into the refrigerating chamber 6.

After the device 7 for withdrawing and feeding the food bases transfers them to the two-axis worktable 4, the control computer 1 instructs, through the software algorithm, servo drives 44 of the two-axis worktable 4 to move a certain distance along the guides 39, so that the near edge of the blank 41 of the food base is directly under one of the containers 8-15 for the food ingredients. This operation becomes possible because the two-axis worktable 4 comprises the guides with linear bearings, a ball screw with a servo drive and a revolution counter on the axis of a servomotor.

The number of the containers 8-15 may be either less or more than that in the figures. The containers 8-15 in this example are arranged sequentially in one row; however, they may be arranged in several rows, arranged in a circle, arranged one above another, and any other arrangements are possible that allow effective application of the food ingredients.

The following data are pre-entered into the control computer 1: the coordinates of the beginning of the zone of action of each of the containers 8-15 with devices 16-23 for processing and issuing the food ingredients. Given this, by transmitting a command to the servo drives 44 to move the two-axis worktable 4 forth or back along the guides 39, the control computer 1 delivers the blank 41 to the place necessary for applying the food ingredient.

The containers 8-15 may have various devices 16-23 for issuing the food ingredients in their lower parts.

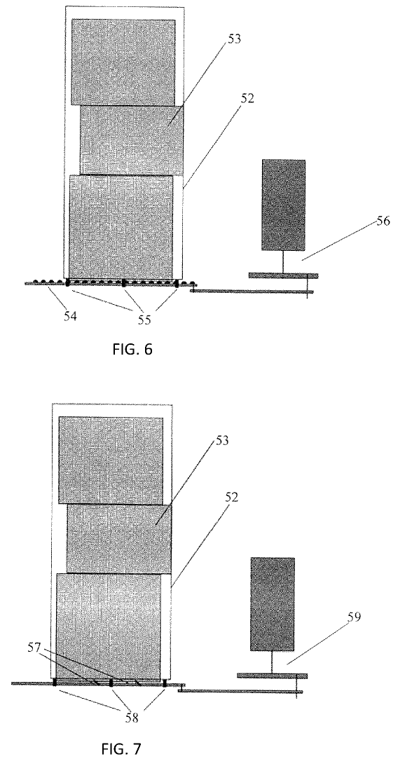

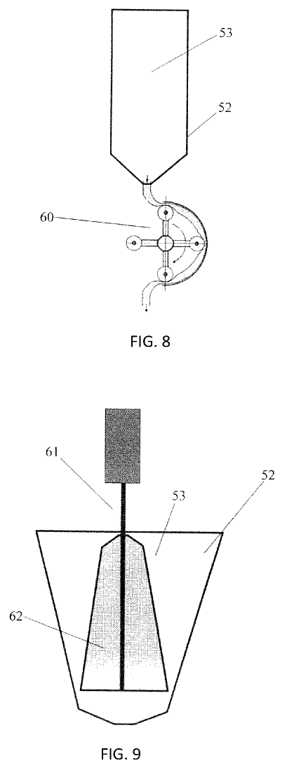

Thus, the container may be intended for solid or semi-solid food ingredients and be equipped with the device for issuing them in the form of a dispenser having a grater (see FIG. 6) or the device for issuing them in the form of a dispenser having knives (see FIG. 7). The container may be intended for liquid ingredients, for which reason it is equipped with the device for issuing them in the form of a peristaltic pump (see FIG. 8). The container may also be intended for free-flowing food ingredients, for which reason it is equipped with a dispenser in the form of a cone crusher (see FIG. 9).

The containers 8-15 may be made of various materials (metal with a special coating, plastic, etc.) that provide long-term storage of the food ingredients. Filling the containers 8-15 with the food ingredients is carried out by a system operator once a day or as they are used up. The containers 8-15 may be equipped with temperature, weight, volume sensors, etc., which are connected to the control computer 1 and transmit a corresponding signal to it in case of deterioration of any parameter.

The devices 16-23 for issuing the food ingredients are also connected to the control computer 1, from which they receive a command as to how much of a certain food ingredient should be applied to a particular blank 41 of food base.

The containers 8-15 operate in a vertical position, which allows using the action of gravity to lower the food ingredients, namely, into the area of action of the dispensers. Additionally, the containers 8-15 may be equipped with rollers, as well as other auxiliary means to facilitate the feeding of the food ingredients.

After the two-axis worktable 4 with the blank of the food base stops under the required container 8-15, the signal from the servo drives 44 enters the control computer 1, as a result of which it instructs the device 16-23 of this container to start the process of applying the contained food ingredient.

The two-axis worktable 4 is configured to move a platform 46 with the blank 41 of the food base to the left and right in relation to the guides 39 along which the worktable 4 itself moves, thereby allowing one to use the fixed (stationary) containers 8-15 because when applying the food ingredient, the platform 46 itself with the blank 41 moves in 4 directions (back-forth, right-left). With such a configuration of the two-axis worktable 4, the food ingredients may be applied to the blanks 41 having a food base of any shape; furthermore, they may be applied to halves, quarters and other parts of the food base to cover the entire surface of the food base in a guaranteed and controlled manner. An additional important advantage of the two-axis worktable 4 should be considered the presence of a third video camera 64 whose produced images of products may be transmitted to the control computer 1 to solve the problem of sending control signals to refine the products when they do not meet the generally accepted standard, information about which is contained in an exhaustive form in the computer system.

Separately, it is necessary to describe the design of the two-axis worktable 4. More specifically, the table comprises a base (baseplate) 43 with the platform 46 installed thereon. The blanks 41 of the food bases are stacked on the platform 46. The platform 46 is configured to move along two guides 39, as in this example, but may move along several guides, with the specified movement being performed back and forth. The platform 46 has an upper part that is configured to move left and right in relation to the guides 39. To move the platform 46, the ball screw servo drives 44 presented in this example are usually used, but other mechanisms may be used, such as encoder-based feedback servo drives, a toothed belt, a pinion-rack/screw-nut pair, a ball screw, a linear drive system with a motor for direct conversion of electromagnetic energy into linear movement, etc. Various mechanisms may also be used as feed drives, such as DC stepper motors, synchronous motors, direct drives, etc.

Under the two-axis worktable 4, according to the present invention, one should understand a certain system that combines the bearing structure of a support, an electromechanical drive, a two-axis movement subsystem, an arbitrary-purpose actuator, information-measuring devices and a control system; in addition, the use of other elements is possible. This certain system is essentially intended for precise linear movement of the platform 46 with the blanks 41 of the food bases along two perpendicular axes in a horizontal plane, namely, the movement of the blank 41 arranged on the platform 46 is performed in the directions back-forth and right-left in relation to the guides 39.

Under the platform 46 of the two-axis worktable 4, weight sensors may be installed, which will allow the control computer 1 to be informed, after each operation, about how much of a certain food ingredient applied to this blank of the food base. If the amount does not meet the standard, the control computer 1 instructs an appropriate dispenser to continue the preparation process.

After the blank 41 of the food base has been coated with all the necessary food ingredients in the right amount on the two-axis worktable 4, it is picked up by a transferring means 26 which is implemented as a pusher-piston and rearranges the blank 41 onto a second transport device configured as an electric conveyor 5. Moving along the endless belt of the conveyor 5, the blank enters an oven unit configured as a conveyor oven 27 where a necessary thermal treatment process is performed. The conveyor oven 27 may be electric, gas, microwave, and any other oven capable of baking the contents.

After baking, the blank 41 moves to a working section 31 which is configured, by using an element 30 for transferring a resulting baked product that is implemented as a pusher-piston, to move the baked food base to a packaging subsystem 33. Before entering the packaging subsystem 33, the baked product may be divided into parts by using a press-mechanism 32 for cutting products. The press-mechanism 32 is also connected to the control computer 1 and, accordingly, receives necessary control signals therefrom.

When entering the packaging subsystem 33, the baked products are placed in packages 35 by means of a mechanism 34 for packaging products which is implemented as a holder-unit having gripping elements holding the package 35 in its lower part with open lids through which the products enter and are transferred further in packaged form, namely, in the form of packaged products 50 by means of a movable feeding element 51 to a subsystem 36 for temporarily storing and issuing the finished and packaged product.

The subsystem 36 is configured to maintain the heated state of the finished products and structurally implies the presence of a vertically oriented conveyor-type device which is based on a flexible working body moving in a closed loop with alternating shelves on which the packaged products 50 are placed. By moving up or down, the packaged products 50 are fed into an automatic window 38 based on the command coming from the control computer 1 in accordance with the previously issued order.

If necessary, the packaged products 50 may be stored for a certain amount of time in the subsystem 36 until they are issued to a customer. At the same time, after the products (pizza, tortilla, burrito, sandwich, shawarma, pies, hamburgers, etc.) are cooked, the control computer 1 sends a command to the central server 2 which sends a notification to a client on his/her mobile device, computer, or in any other way, including notifying the operator that the product is ready and subject to transfer to a specific customer.

If the order was placed remotely via the Internet network, the received notification comprises a secret code that allows one to identify this customer, whereupon the customer approaches the issuance window 38, enters this code on the touchscreen 37, or brings a mobile device to a reader and shows a QR code received from the central server 2.

The program installed on the control computer 1 identifies this client and activates the opening of the automatic window 38 which received the product selected earlier in accordance with his/her order, thereby allowing the ordered product to be received in a safe and secure manner.

The software of the control computer 1 is configured to track the time of product readiness, which is indicated to the client when confirming the order and notifying the client about the readiness of the order. If preset storage time passes after the notification of the readiness of the order, the order goes into the “not selected” status and is subject to disposal.

It is important from the point of view of the inventive concept that a first video camera 25 is installed on a special stand at the output of the two-axis worktable 4, namely in vicinity of its end part. Furthermore, the two-axis worktable 4 itself comprises the third video camera 64. During the movement of the two-axis worktable 4, the first video camera 25 and possibly the third video camera 64 transmit, to the control computer 1, information about the appearance of the blank 41 of the food base before and after the application of each food ingredient, as well as video monitoring of the absence of foreign and inadmissible objects on the blank 41 is also carried out. If the software of the control computer 1 determines a low quality assessment and shortcomings of the analyzed blank 41 of the food base, for example, the uneven application of the food ingredient, then the control computer 1, having determined this fact, may instruct the two-axis worktable 4 to change the position of the unfinished blank in relation to the desired container 8-15, in order to apply the required amount of the food ingredient. If it is established that an invalid object is on the blank, the control computer immediately instructs the two-axis worktable 4 to move the low-quality blank close to an actuator 24 for withdrawing a thermally untreated product of inadequate quality.

The actuator 24 for withdrawing the thermally untreated product of inadequate quality is arranged within the transfer section of the two-axis worktable 4 and is implemented as a separate installed module equipped with a piston-pusher having a stop and configured to withdraw low-quality products. More specifically, when the two-axis worktable 4 with a dough piece to be withdrawn moves to the actuator 24, then the piston-pusher pushes the blank into a storage 45. As an alternative option for removing a low-quality dough piece, a controlled unit may be used, which is arranged directly on the platform 46, comprises a pusher 47 and a piston 48 with a stop which substantially move the low-quality products to the storage 45 on command.

According to allowable operation modes, the processes of controlling the application of the food ingredients are carried out until all the necessary food ingredients are applied to the blanks 41. If the blank is disposed of without the possibility of its recovery, then the control computer 1 instructs the two-axis worktable 4 to move a desired portion to the area of issuing new blanks and re-execute the entire food ingredient filling process with the same high-quality control.

If the control computer 1 decides that there are no violations in the preparation and layout of dough and the blank meets all previously laid down standards, a decision is made to move the two-axis worktable 4 with the corresponding blank to the means 26 for transferring the partially finished product to the conveyor oven 27.

Additionally, in the exit zone from the conveyor oven 27 in the exit area (end part) of the electric conveyor 5 with the endless metal belt, a second video camera 29 is installed on a special stand and is also connected to the control computer 1. This camera 29 transmits photo and video images of a baked product (pizza, tortilla, burrito, sandwich, shawarma, pancakes, pies, hamburgers, etc.) to the control computer 1 where the software evaluates the quality of the product. If the quality does not meet the previously laid down and generally accepted standards or foreign objects are found in the baked product, then this baked product is transferred to a storage for products to be disposed of, like the storage 45, by using an actuator 28 for withdrawing the thermally treated product of inadequate quality. The actuator 28 is arranged within the transfer section of the electric conveyor 5 with the endless belt and is implemented as a separate installed module equipped with a piston-pusher having a stop and configured to withdraw low-quality baked products. At the same time, in the case of disposal of the baked product (pizza, tortilla, pies, pancakes, burrito, shawarma, hamburgers, etc.), the control computer 1 sends a command to repeat the preparation process of this product, starting from the process of issuing the blank 41 of the food base from the refrigerating chamber 6 and ending with the re-baking of the food base according to the same order.

The most important thing is that almost all the cooking time, the products are in the coverage area of the first and second video cameras 25 and 29, respectively. Due to this, at almost all production stages of the products, “manual” quality control may also be carried out by the system operator on a monitor, which allows one to stop the equipment operation in case of a clear violation.

Regarding the comparison of the received images of the products being prepared with the numerous images of the reference products previously loaded into the control computer 1, it is important to report the following.

The software of the control computer 1 and the central server 2 comprises artificial intelligence elements.

The initially used computer program displays and downloads hundreds of thousands of images of products (pizza, tortilla, burrito, shawarma, pies, pancakes, sandwiches, hamburgers, etc.) that meet the generally accepted standards and are reference. The product parameters are evaluated by programmers and the results of the evaluation are reported to the program. This program is informed about the existing shortcomings of this product by graphically highlighting those elements of pizza that do not meet the requirements, for example, an insufficient amount of some food ingredient in a certain area of this product, poor sauce or cheese application, dough defects, a size mismatch, an irregular shape, the presence of foreign objects, etc.

The artificial intelligence of the control computer 1 evaluates the state of the blank 41 of the food base after the accomplished technological operation, comparing it with photographs of the reference (generally accepted, corresponding to international quality standards) products present in its database. As already mentioned, in parallel, the control computer 1 may optionally receive data on the weight of the products, which allows one to determine the amount of the applied food ingredient which is compared with the established and previously laid down standard.

All the checking data are sent to the central server 2 and, if it is found that the blanks do not meet the production quality according to any criteria or contain foreign objects, a signal is immediately generated and sent for withdrawing and disposal of products. In some cases, a signal may be sent to a service operator to stop the production for technical reasons, requiring the personal intervention of maintenance personnel.

An optional (additional) assessment method which will allow software with artificial intelligence elements to improve the quality of analysis and to self-learn, involves comparing the received numerous photographs of finished blanks and finished products with consumer ratings, i.e., the consumer ratings regarding a specific product with its photo attached and descriptions of shortcomings made in the software application or at the manufacturer’s website.

Thus, it is shown that the fundamental technological operations which determine the purpose and desired performance of the proposed technology are the technical possibility of generating an electronic order indicating the type and parameters of a desired product, which may be compiled and activated by both a user and an operator and enters the computer system (central server 2 and control computer 1) that, processing them, forms and approves previously programmed control commands that support certain operation modes and parameters necessary for the high-quality preparation of each order separately. As a result of this, a fully automated production process is implemented, consisting in storing the food bases in the refrigerating chamber 6, feeding blanks to the two-axis worktable 4 and the electric conveyor 5, filling the food bases with contents through the containers 8-15, baking the products in the conveyor oven 27, packaging the products by using the packaging subsystem 33, as well as issuing to the customer the finished products through the subsystems 36 for storing and issuing the finished and packaged product. At the same time, the quality and safety of these operations are additionally supported by command and executive product quality monitoring tools (the computer system, the first and second video cameras 25 and 29, as well as the actuators 24 and 28 for withdrawing the products of inadequate quality), which comprehensively carry out a continuous production process with total control, as well as by the software quality analysis which allows automated withdrawal of the products that have not passed the check.

According to the inventive concept, the key equipment that receives and processes incoming digital orders is the central server 2 connected to the Internet or to a similar network transmitting information to the control computer 1 which, in turn, processes the received signals about the selection of certain products and their preparation modes, generates control commands that determine the entire production cycle of certain products and the operation modes and features of the two-axis worktable 4 and the electric conveyor 5 by which the products are moved, the refrigerating chamber 6, the devices for feeding the food ingredients (i.e., the containers 8-15), the conveyor oven 27, as well as the packaging subsystem 33 and the subsystem 36 for storing and issuing the finished products.

Thus, according to the proposed technology, the integrated management of the presented technological capabilities is implemented, the uninterrupted automatic operation and consistency of all the main and auxiliary systems used are ensured, including the organization of processing and generation of control commands, the automatic reproduction of which provides the coordinated and organized operation of the systems with a definitely high level of manufacturability, complemented by the controlled and technically advanced operation of the monitoring tools, which implies the software analytical analysis of the quality of both finished and partially finished products. This provides an unprecedented increase in production safety, improved control, as well as the corresponding product quality features that are comparable to those peculiar to reference products, including those produced by hand.

The proposed system may be equipped with UV lamps 63 which periodically or continuously, depending on their settings, treat the equipment from bacteria.

In the presented embodiment, the main production equipment is operatively combined for visual inspection and is covered with the transparent protective showcase 3.

For security purposes, the combined equipment may be limited on all sides by a housing fence comprising a service opening.

The equipment may be configured as a vending machine or as a system which may be installed on a vehicle or installed indoors as a stationary retail facility.

The proposed invention can be successfully used in the food service sector as a safe and technologically advanced technique for producing instant flour food products.

1. A method for automatically preparing and packaging ready-to-eat flour products, comprising:
generating a selected order which is provided as a digital information signal from a central system server to a local control computer connected to an Internet network, wherein the control computer processes the information signal, approving programmed control commands and operation modes of system components, whereupon a necessary food base which is placed in a cooling unit is fed by a device for withdrawing and feeding food bases to a first transport device where the food base is filled, in a prescribed manner, with certain food ingredients emitted from containers installed above the first transport device;
after that, feeding a partially finished product by a transferring means to a second transport device, moving along which the partially finished product is baked until cooked in an oven unit;
after the oven unit, providing the baked product to a working section configured to transfer the baked product to a packaging subsystem connected to a subsystem for temporarily storing and issuing a finished and packaged product, which feeds the ordered product to an automatically opening user area;
wherein digital product quality monitoring tools are installed at outlets of the first and second transport devices, and images of products are transmitted to a computer system which analyses the received images by comparing the received images with reference images, and in case of an unsatisfactory comparison result, generates and transmits a signal to withdraw low-quality products, which is implemented by actuators.

2. The method for automatically preparing the flour products according to claim 1, wherein the digital product quality monitoring tools comprise a photo and/or video camera.

3. The method for automatically preparing the flour products according to claim 1, wherein the first transport device is implemented as a movable two-axis worktable mounted on guides.

4. The method for automatically preparing the flour products according to claim 3, wherein the two-axis worktable comprises a base having a movable platform installed thereon, the movable platform having a lower part configured to move in a longitudinal direction and an upper part configured to move in a transverse direction.

5. The method for automatically preparing the flour products according to claim 3, wherein the two-axis worktable is equipped with a digital product quality monitoring tool.

6. The method for automatically preparing the flour products according to claim 5, wherein the digital product quality monitoring tool is implemented as a photo and/or video camera.

7. The method for automatically preparing the flour products according to claim 5, wherein the control computer is configured to: analyze the received images from the product quality monitoring tool installed on the two-axis worktable mainly in combination with the received images from a product quality monitoring tool installed on an exit section of the two-axis worktable; generates, in case of incomplete reference compliance of the products, programmed command signals that activate desired operation modes of equipment which are aimed at eliminating deficiencies of the products.

8. The method for automatically preparing the flour products according to claim 1, wherein the first transport device is implemented as a conveyor device having an endless belt.

9. The method for automatically preparing the flour products according to claim 1, wherein the second transport device is implemented as a conveyor device having an endless belt.

10. The method for automatically preparing the flour products according to claim 1, wherein the cooling unit is a refrigerating chamber for storing the food bases which is structurally docked with the first transport device.

11. The method for automatically preparing the flour products according to claim 1, wherein the containers by which the food bases are filled with the food ingredients in a prescribed manner are installed sequentially in a row and comprise free-flowing, pasty, solid, semi-solid and liquid additives.

12. The method for automatically preparing the flour products according to claim 1, wherein the working section is equipped with a checkweigher configured to measure a weight of the products, and data on the weight are used by the computer system when analyzing the received images, wherein if this parameter deviates from pre-loaded statutory indicators, a decision is made to withdraw the low-quality products.

13. The method for automatically preparing the flour products according to claim 1, wherein the working section is equipped with a press-mechanism for cutting baked products.

14. The method for automatically preparing the flour products according to claim 1, wherein the applied production equipment is operatively combined into a system and covered with a transparent protective showcase for safe and visual viewing.

15. The method for automatically preparing the flour products according to claim 1, wherein the actuators are arranged within transfer sections of the transport devices and implemented as separate controllable modules equipped with a piston-pusher having a stop and configured to transfer the low-quality products to a storage.

16. The method for automatically preparing the flour products according to claim 1, wherein the actuators are arranged on movable parts of the transport devices and represent separate controllable units configured as a piston-pusher having a stop and configured to transfer the low-quality products to a storage.
